(19) United States
(12) Patent Application Publication
(10) Pub. No.: US 2016/0361908 A1
(43) Pub. Date: Dec. 15, 2016

(54) METHOD FOR PROCESSING OR MANUFACTURING A 3D PRINTED OBJECT

(71) Applicant: MCOR Technologies Limited, Dunleer (IE)

(72) Inventors: Fintan MacCormack, Ardee (IE); Conor MacCormack, Ardee (IE)

(21) Appl. No.: 15/180,470

(22) Filed: Jun. 13, 2016

Related U.S. Application Data
(60) Provisional application No. 62/174,378, filed on Jun. 11, 2015.

(51) Int. Cl. B32B 37/12; D21H 19/56; B32B 7/12; D21H 17/37

(52) U.S. Cl. CPC B32B 37/12; D21H 17/375; D21H 19/56; B32B 7/12; B32B 2317/12; B32B 2255/12; B32B 2260/046; B32B 2260/028

(57) ABSTRACT

A method of forming a flexible or resilient 3D object, the method including: providing a 3D object, the 3D object comprising a plurality of media layers assembled together to form the object, wherein the media layers are of a porous material; providing a post treatment post; applying a post treatment formulation to the object or portions of the object to render the object or portions of the object resilient or flexible.

### CROSS REFERENCE TO RELATED APPLICATION

The present application claims priority to U.S. patent application No. 62/174,378 filed on Jun. 11, 2015, entitled “Method for Processing or Manufacturing a 3D Printed Object,” the entire disclosure of which is incorporated by reference herein.

### FIELD

The present application relates a method for manufacturing a 3D printed object of required properties. In particular the present specification provides a method for processing or treating a 3D printed object.

### BACKGROUND OF THE INVENTION

Rapid prototyping is defined as computer-controlled additive fabrication, in that an object can be fabricated by the addition of material rather than conventional machining methods that rely on removal or the subtraction of material. The term “rapid” is, it will be appreciated, a relative term but one that has specific meaning within the art, in that construction of a finished three dimensional articles can take from several hours to several days, depending on the method used and the size and complexity of the model. There are many known methodologies that are employed within the general field of rapid prototyping Layered Object Manufacture (LOM) is one form of Rapid prototyping (RP) which relates to the successive layering of adhesive-coated paper, plastic, or metal laminates which are then successively glued together and cut to shape with a knife or laser cutter.

LOM, similarly to other rapid prototyping techniques, conventionally involves the use of a three dimensional (3D) computer aided design (CAD) of an object/part to be made, from which a stereolithography (STL) or other suitable format file is generated within a CAD package. The STL file is processed and in effect virtually sliced in the Z-axis at a thickness matching the thickness of the substrate material used. This creates a series of cross sections of the part and at any particular height each one has a simple two dimensional (2D) profile. A profiling, or cutting, apparatus may be used to trace the 2D profiles and thus cut the shapes onto thin sheets of raw material. In LOM, each individual thin sheet may be stacked and bonded one on top of another to produce a finished 3D object. After a plurality of media object layers are formed, a profiling and layer bonding process is performed. The plurality of layers are bonded together, and then a profiling or weeding process is performed which comprises removing unwanted support material from the printed media stack to reveal the 3D printed object. The order of the profiling, stacking and bonding processes may be interchanged. The individual layers may also be printed using conventional 2D printing processes. The layers may be singly or duplex printed, and printed either in a single colour such as with black ink, or colour printed with a plurality of colours. In addition multi-coloured paper may be used.

In LOM manufacturing, typically a finished 3D object is formed from a stack of individual media layers which are assembled and profiled to form the desired final geometrical shape. The individual media layers may be printed or otherwise treated prior to the assembly stage of the manufacturing.

Accordingly, a plurality of 3D object media layers may be printed in preparation for forming the finished 3D printed article. The entire layer stack for the 3D printed article may be pre-printed off-line in the printing module, after which the printed stack may be loaded into the profiling and layer bonding module where each printed layer may be profiled and bonded to complete the fabrication of the 3D printed article.

The overall final 3D object will often have properties similar to the material or media used to form the object. 3D printed objects of plastic or metal are often solid objects.

The present specification provides a method for processing a 3D printed object.

### SUMMARY

According to the present specification there is provided a method of post treatment of a 3D printed object, the method including:
providing a 3D object, the 3D object comprising a plurality of media layers assembled together to form the object, wherein the media layers are of a porous material;
providing a post treatment formulation;
applying a post treatment formulation to the object or portions of the object to render the object or portions of the object resilient or flexible.

Advantageously, the post treatment provides a durable finish to the overall surface of the object while ensuring integrity under flexing or other externally applied forces.

According to the present specification there is provided a method of post treatment of a 3D printed object, the method including:
providing a 3D object, the 3D object comprising a plurality of media layers assembled together to form the object, wherein the media layers are of a porous material;
providing a post treatment formulation;
applying a post treatment formulation to the object or portions of the object wherein the treatment formulation is configured as an infiltrant material; and the porous material of the media layers are configured to act as a scaffold for the treatment formulation enabling it to take on the properties of the infiltrant material.

The post treatment formulation is for post treating the layered object.

The present specification provides a method for processing a 3D printed object. The method advantageously provides a 3D printed object of durability which may be used for example as a wearable object or in other applications. The method provides processing of a 3D printed object to render the object or portions thereof resilient or flexible. The processing advantageously provides a durable, hard wearing and resilient or flexible object and may be applied in many fields to provide an alternative form of object manufactured by 3D printing.

The post treatment formulation being configured to render the overall object or portions of the object to which it is applied flexible. The treatment formulation being configured to render the overall object or portions of the object to which it is applied resilient.

The post formulation has been termed a treatment formulation to highlight that the formulation may be applied as a post treatment to the 3D objection. The formulation has been termed a treatment formulation to highlight that the formulation is for treatment of manufactured object to modify or change the final finished object and/or properties thereof. The treatment adds new features to the treated object.

The post treatment formulation has been described in the specification in various terms including: a flex treatment, flex treatment formulation, flex treatment liquid, or flex treatment emulsion, such terms have been used interchangeably. The composition of the formulation is such that it is absorbable into the media layers of the object. The treatment which comprises application of the treatment formulation to the object renders the overall object resilient or flexible. The formulation is a post-treatment formulation that provides a finish to the layered object.

The media layers may be of paper. The media layers may be of a porous material not paper.

The treatment formulation may be configured as an infiltrant material. The porous material of the media layers may be configured to act as a scaffold for the treatment formulation enabling it to take on the properties of the infiltrant material.

The treatment formulation may comprise a water based emulsion. The treatment formulation may comprise an acrylic polymer. The treatment formulation may comprise a colloidal suspension of an acrylic polymer in water. The treatment formulation may further comprise a pigment dispersed in the suspension. The treatment formulation may be formulated such that when exposed to the atmosphere or otherwise dried, the water in the treatment formulation evaporates or is absorbed into the object.

The treatment formulation may be formulated such that after application of the treatment formulation, as the water leaves the system of the formulation in the porous material, the polymer molecules interact and polymerise.

The treatment formulation may be formulated such that as the polymer particles fuse together, they form a stable film around the object.

The treatment formulation may be formulated such that the film formed around the object may include the encapsulated pigment. The treatment formulation may be formulated to penetrate through a predefined depth of a media layer or media layers of the object.

The treatment formulation is applied by spraying the treatment emulsion onto the object, or, by immersing the object in the treatment formulation. It will be appreciated that other suitable application means may also be used.

According to another aspect there is provided a method of forming a colour 3D object comprising a plurality of media layers wherein each media layer is processed to define a layer of the object, the processing of each media layer to define a layer of the object including:
cutting the profile of the layer
applying adhesive
bonding the layer to a preceding layer or base layer of the object repeating the processing of each successive layer until the object is formed, wherein the media layers are of a porous material,
further including applying a post-treatment formulation to render the object or portions thereof resilient or flexible.

The post treatment provides a durable finish to the overall surface of the object while ensuring integrity under flexing or other externally applied forces.

The treatment formulation may be applied to the built object.

In one arrangement the media layers are of paper. In one arrangement the media layers are of a porous material not paper. The porous material of the media layers is configured to act as a scaffold for the treatment formulation enabling it to take on the properties of the treatment material.

The treatment formulation is configured as an infiltrant material. The treatment formulation may comprise one of: an emulsion, a water based emulsion, an acrylic polymer, a colloidal suspension of an acrylic polymer in water. The treatment formulation may further comprise a pigment dispersed in the suspension. The treatment formulation may be formulated such that when exposed to the atmosphere or otherwise dried, the water in the treatment formulation evaporates or is absorbed into the object. The treatment formulation may be formulated such that after application of the treatment formulation, as the water leaves the system of the formulation in the porous material, the polymer molecules interact and polymerise. The treatment formulation may be formulated such that as the polymer particles fuse together, they form a stable film around the object.

The treatment formulation is applied to the object or selected portions of the object after the object has been built. The treatment formulation is applied by spray application or by immersing the object in the formulation.

According to a further aspect there is provided a method of treating to a 3D object, the 3D object comprising a plurality of layers of a paper material, to render selected portions of a layer or layers of the object at least partially flexible,
the method comprising:
providing the 3D printed object and a treatment emulsion;
applying the treatment formulation to at least selected portions of the object, wherein as the treatment formulation is absorbed into a media layer the media layer is rendered flexible.

In one arrangement there is provided a method of post treatment of a 3D printed object, the method including:
providing a 3D printed object, the 3D printed object comprising a plurality of media layers assembled together to form the object, wherein the media layers are of a porous material;
providing a post-treatment formulation;
applying a post-treatment emulsion to the object or portions of the object to wherein the post treatment formulation is configured as an infiltrant material;
wherein the porous material of the media layers provides a scaffold for the post treatment formulation;
the post treatment formulation comprising a colloidal suspension of an acrylic polymer in water;
wherein the post treatment formulation is formulated such that after application of the post treatment formulation, as the water leaves the system of the post treatment formulation in the porous material, the polymer molecules interact and polymerise and form a stable film around the object.

### BRIEF DESCRIPTION OF THE DRAWINGS

The present application will now be described with reference to the accompanying drawings in which:

FIG. 1A is a flow chart showing possible steps of methods according to embodiments of the present teaching; the first method relates to the processing of a 3D object to render at least portions of the 3D object flex, the 3D object being comprised of a plurality of layers of a medium, for example paper;

FIG. 1B relates to an exemplary method relating to applying a treatment to at least portions of individual of media layers defining layers of a build object at a build location to form a 3D object.

### DETAILED DESCRIPTION OF THE DRAWINGS

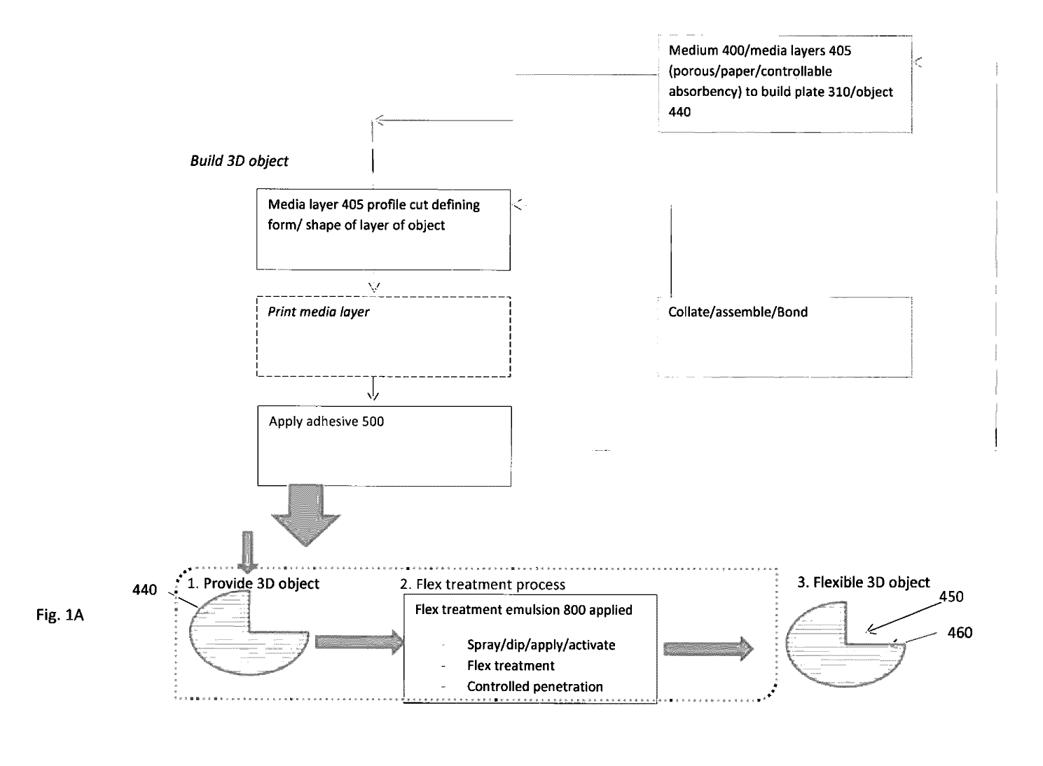

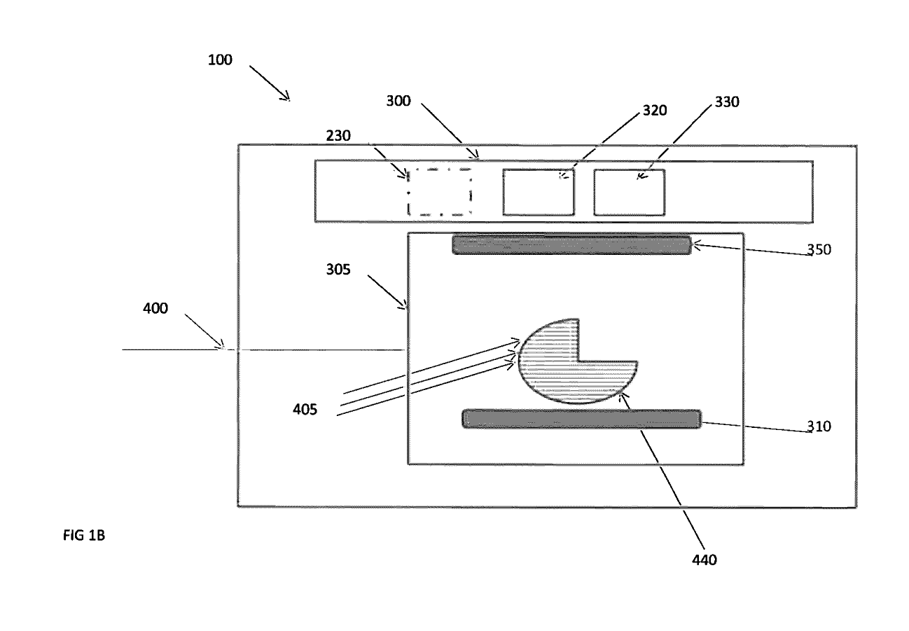

Referring to the drawings and initially in particular FIG. 1 methods are provided for manufacturing a flexible 3D object 450. The methods relate to a processing of 3D object 440, comprising a plurality of media layers 405 which are assembled to form the object, to provide a durable finish to the overall object. The post treated overall object has resilience and durability. The media layers of medium 400 are of a porous material. In the exemplary arrangement of FIG. 1 the media layers 405 are of paper. Individual media layers 405 of the object in the exemplary arrangement may be bonded together using an adhesive 500 to form the 3D object. The adhesive 500 may comprise a water based adhesive.

The method in particular relates to applying a treatment to a 3D object 440 to render the object or portions thereof flexible. The 3D object comprises an object manufactured from a plurality of media layers. The object 440 may be built for example using a system and method in accordance with WO2009068672 or other systems provided by MCOR Technologies Limited. If will be appreciated that the method of rendering a 3D object of a plurality of media layers is not limited to objects manufactured using the systems provided by MCOR Technologies Limited, objects built using a different systems may also be treated according to the methods of the present specification.

In the specification, the processing or treatment of the 3D object comprises application of a post treatment material to the object. This treatment material is referred to as a flex or flexible treatment emulsion or treatment emulsion or liquid or formulation or material 800. The treatment formulation is a formulation applied to the object to render it resilient or flexible. The treatment 800 may be applied to the object 440 when built. The treatment formulation 800 may be applied to portions of the object. The flexible treatment formulation 800 may be applied to media layers defining layers of the object or to portions of media layers defining layers of the object during manufacture.

The formulation 800 is configured for application to an object to render the object flexible or resilient. The flexibility or resilience of the object is increased relative to that prior to the treatment. One exemplary use of the formulation is to treat a layered object of a plurality of layers of paper for example having a circular band form to form a bracelet. The treatment or application of the formulation to the object renders it flexible or resilient. After treatment the finished object is used as a bracelet having resilience and elasticity relative to the untreated object.

As noted, the media layers 405 of the object 440 are of a porous material. The treatment material 800 is configured as an infiltrant material. The porous material of the media layers is configured to act as a scaffold for the treatment material 800 enabling the media layers to take on the properties of the infiltrant material.

According to the methods of the specification, the treatment material 800 is absorbed into the media layers or portions of the media layers of the object.

Referring FIG. 1A an exemplary method according to the present specification is described. Object 440 is provided for treatment or processing to render the object or portions thereof flexible, as required. The treatment formulation 800 is provided.

In the exemplary arrangement, the object 400 is a 3D object formed from a plurality of media layers. The media layers 405 are of a porous material bonded together by an adhesive 500. The media layers 405 are of a paper. The media layers may be bonded by a water based adhesive 500. Individual media layers are processed to define layers of the object. The paper of the layers of the object is configured to act as a scaffold for the treatment material 800 enabling it to take on the properties of the infiltrant material.

As noted above, the object to be processed may be produced by a variety of methods. In an exemplary arrangement the processing for form the object may include: cutting the profile of media layers to define the form and profile of layers of the object. The processing may include printing portions of media layers to define the colour of the layer of the object. Each individual media layer is processed as required and the overall 3D object 440 is formed by the assembly or bonding of the individual media layers together.

The object 440, whether manufactured as described above or by another method, is further processed according to the method of the present specification by application of a post treatment material 800 to render the overall object flexible or resilient in comparison with the object prior to treatment.

Taking an object 440 formed from a plurality of layers 405 of a paper material. Paper is a porous material having a porosity of the order of 70%. The porous paper acts as a scaffold for the treatment material 800 enabling it to take on the properties of the infiltrant material—in this case the flex treatment material 800.

The properties of the treatment material or flex treatment formulation 800 may be controlled as required to provide the desired final product.

For example, the formulation 800 may be prepared or formulated as a quick drying formulation. Such a formulation of the material 800 may be used if only the external portions of an object are to be treated.

The flex treatment 800 may be formulated to have a higher or lower level of absorbency into the layers of the object, for example, from the edges of the layers. For example, the viscosity may be varied as required.

The flex material 800 may be formulated to dry quickly. The flex material 800 may be formulated to dry with a clear thin film. The treatment material 800 or flex treatment emulsion 800 may in the exemplary method of FIG. 1A comprise a water based emulsion. The material 800 or treatment 800 may comprise an acrylic polymer. The treatment material 800 may comprise a colloidal suspension of an acrylic polymer in water. The emulsion 800 may further include a pigment dispersed in the suspension.

The treatment emulsion 800 may be formulated such that when exposed to the atmosphere or otherwise dried, the water in the emulsion 800 may evaporate or be absorbed into the object 440.

One exemplary use of the formulation is to treat a layered object of a plurality of layers of paper for example having a circular band form to form a bracelet. The treatment or application of the formulation to the object renders it flexible. After treatment the finished object is used as a bracelet having resilience and elasticity relative to the untreated object. In the exemplary arrangement, the flex treatment material comprises a water based emulsion comprising a colloidal suspension of an acrylic polymer in water.

In the exemplary arrangement of FIG. 1A after application of the flex treatment 800, as the water leaves the system of the emulsion in the porous material, the acrylic polymer molecules are close enough to interact and polymerise. As the polymer particles fuse together, they form a stable film 460 around the object 450. The film 460 may, as noted above, include the encapsulated pigment.

This method or process according to an exemplary arrangement of the present specification results in an object 450 which has a permanent water-insoluble colour. The method or process according to the present specification results in an object 450 which has a surface that is flexible or resilient and will remain free of cracks and chips.

The ratio of acrylic polymer and water in the flex treatment 800 may be tuned so that the water will not spread the acrylic resin too thinly, and interfere with the formation of the stable film.

Advantageously, the flex treatment material 800 may be odour neutral and non-toxic.

Different approaches to application of the treatment 800 are provided. In an exemplary arrangement, the treatment 800 is applied to a 3D object 440 by spraying. In another exemplary arrangement, the treatment 800 is applied by dipping or immersing the object 440 or portion thereof into the formulation or emulsion 800.

The treatment 800 may be applied to the finished object 440. The treatment 800 may be applied to selected portions of the object. The treatment 800 may be applied to individual layers of an object or portions thereof.

Reference is made to the flow diagram FIG. 1b which illustrates an exemplary method of the present specification.

The specification further provides a method of manufacturing a 3D layered printed object which is flexible or resilient or an object which is at least partially flexible or resilient,.

In an exemplary arrangement, the object 400 is a 3D object formed from a plurality of media layers. The media layers are of a paper material bonded together. The media layers may be bonded by an adhesive. Individual media layers are processed to define layers of the object. The processing may include: cutting the profile of the media layer to define the form and profile of the layer of the object. The processing may include printing portions of the media layer to define the colour of the layer of the object.

The object treated using the treatment formulation 800 the object, has a flexibility, resilience and suppleness in comparison with the pre-treated object. The terms resilient and flexible have been used essentially interchangeably and refer to the durability provided by the post treatment to the overall surface and form of the object which provides integrity under flexing or other externally applied forces.

Each individual media layer is processed as required and the overall 3D object 400 is formed by the assembly or bonding of the individual media layers together.

The system 100 comprises processing means 300 and a build chamber 305. The system includes cutting means 320, adhesive application means 330 and bonding means 350. The system includes build plate 310. The system may further include printing means 230. Medium 400 is provided to the system. Object 440 is manufactured from media layers 405 of medium 400. As noted the object 440 may be produced by other means, however, the arrangement of system 100 is noted to provide background and to assist in the understanding of the methods.

Media layers are processed individually to define a layer of the object.

The media layer is processed including:
Profile cut to form layer 405 of the object

Cutting the media layer to define an external profile and/or one or more internal profiles of a layer

The processing may further comprise:
Printing the media layer to define a colour layer of the object
   (Ink applied to at least a portion of the media layer).

In an alternative arrangement, the media layers may be printed off line.

The processing of the media layers in the exemplary arrangement further comprises
Bonding a media layer to the build.

The processing of the media layer may further comprises
applying adhesive to the printed and/or profiled media layer.

Bonding a media layer to a build may comprise bonding the media layer to a base (first media layer) or bonding a media layer to the preceding media layer.

The method further provides processing of the object to render at least portions thereof flexible.

The processing includes:
Applying a treatment 800.

The terms treatment, post or flex or flexible treatment or emulsion, or material, or formulation, have been used to describe the treatment which is formulated to render the overall object or portions thereof flexible or resilient. The object is relatively durable in comparison with the object prior to treatment. As described, in further detail below, a treatment 800 may be applied to an object to produce a final desired finish. Part, or all, of the object 440 may be treated by application of the treatment. The treatment 800 is formulated to interact with the media layers 405 of the object 440. In an exemplary arrangement, the object is manufactured from a plurality of media layers of paper. A treatment 800 may be applied to render the paper from an external surface of the object and throughout the depth and the extent of the layers of the object flexible to achieve the required effect and a finished object have properties, as desired. For example the object may be submerged in the formulation for a particular period of time to allow the formulation to be absorbed. In an exemplary arrangement a post treatment 800 may be applied to render a portion of the object flexible. For example, the formulation may be applied to one or more surfaces. The treatment may be applied to create an object having a particular finish for a specific application.

The properties of the post-treated overall object are defined by the basic form of the object and the physical interaction of the bonded individual layers of the object primarily with the layers above and below. The post treatment further provides an infiltrant to the already bonded porous layers of the object. The post treatment provides further physical interactions of the molecules of the treatment material with the object including a stable film around the object and an infill of pores. The physical properties of the object are also defined by geometry of the object. However, the layered object may be delicate under flexing or other externally applied forces. The post treatment provides a durable finish to the overall surface of the object while ensuring integrity under flexing or other externally applied forces.

For example as the system of the formulation in the porous material dries, the polymer molecules interact and polymerise. The treatment formulation may be formulated such that as the polymer particles fuse together, they form a stable film around the object.

The apparatus 100 is configured to provide 3D printing or manufacture of a 3D build object by SDL by collating, bonding, profiling of the successive media layers. The media layers are assembled at the build chamber 305. Each media layer is processed as required to define a layer of the object. The collation or build chamber 305 provides for the building of the 3D object. The build chamber 305 comprises a build plate 310. The system comprises processing means 300 which may include adhesive dispensing means 320, cutting means 330. The build module 305 may further include a heated plate 350 or other collating or bonding means. It will be understood that the layers of the object may be processed off-line for subsequent collation and bonding. It will be appreciated that the layers of the object may be printed off-line for subsequent collation and bonding.

The treatment material 800 may be a fast-drying, non-toxic and have a sufficiently high enough viscosity such that they already begin to form a solid film before they can penetrate through a significant number of layers.

The methods of the present patent specification provides improved results in 3D printing providing for flexible or resilient objects or portions thereof.

The arrangement of the present specification provides a new form of 3D printed object. The flexibility or resilience and finish of an overall 3D printed object may be controlled as required. The flex treatment of 3D paper objects may be used for example for making durable 3D objects, water resistant 3D objects, or hard wearing 3D object. The objects would be suitable in a variety of applications including wearable 3D objects for example jewellery.

The words comprises/comprising when used in this specification are to specify the presence of stated features, integers, steps or components but does not preclude the presence or addition of one or more other features, integers, steps, components or groups thereof.

1. A method of post treatment of a 3D printed object, the method including:
providing a 3D object, the 3D object comprising a plurality of media layers assembled together to form the object, wherein the media layers are of a porous material;
providing a post-treatment formulation;
applying a post-treatment emulsion to the object or portions of the object to wherein the post treatment formulation is configured as an infiltrant material;
wherein the porous material of the media layers is configured to act as a scaffold for the post treatment formulation;
wherein as the formulation dries in the porous material, the molecules thereof, interact and form a stable film around the object.

2. The method of claim 1 wherein the media layers are of paper.

3. The method of claim 1 wherein the media layers are of a porous material not paper.

4. The method of claim 1 wherein the post treatment formulation comprises a water based emulsion.

5. The method of claim 1 wherein the post treatment formulation comprises an acrylic polymer.

6. The method of claim 1 wherein the post treatment formulation comprises a colloidal suspension of an acrylic polymer in water.

7. The method of claim 1 wherein the post treatment formulation further comprises a pigment dispersed in the suspension.

8. The method of claim 1 wherein the post treatment formulation is formulated such that when exposed to the atmosphere or otherwise dried, the water in the post treatment formulation evaporates or is absorbed into the object 400.

9. The method of claim 1 wherein the post treatment formulation is formulated such that after application of the post treatment formulation, as the water leaves the system of the formulation in the porous material, the polymer molecules interact and polymerise.

10. The method of claim 9 wherein the post treatment formulation is formulated such that as the polymer particles fuse together, they form a stable film around the object.

11. The method of claim 1 wherein the post treatment formulation is formulated such that the film formed around the object may include the encapsulated pigment.

12. The method of claim 1 wherein the post treatment formulation is formulated to penetrate through a predefined depth of a media layer or media layers of the object.

13. The method of claim 1 wherein the properties of the object or media layers of the object are controlled to control absorbency of the post treatment formulation into the object.

14. The method of claim 1 wherein the post treatment formulation is applied by spraying the post treatment formulation onto the object, or, by immersing the object in the post treatment formulation.

15. A method of forming a colour 3D object comprising a plurality of media layers wherein each media layer is processed to define a layer of the object, the processing of each media layer to define a layer of the object including:
cutting the profile of the layer
applying adhesive
bonding the layer to a preceding layer or base layer of the object repeating the processing of each successive layer until the 3D printed object is formed, wherein the media layers are of a porous material,
further including applying a post treatment formulation to render selected portions the object resilient or flexible.

16. The method of claim 15 wherein the media layers are of paper or wherein the media layers are of a porous material not paper; and the porous material of the media layers is configured to act as a scaffold for the post treatment formulation enabling it to take on the properties of the post treatment formulation.

17. The method of claim 15 wherein the post treatment formulation is configured as an infiltrant material and comprises one of: a water based emulsion, an acrylic polymer, a colloidal suspension of an acrylic polymer in water.

18. The method of claim 15 wherein the post treatment formulation further comprises a pigment dispersed in the suspension.

19. The method of claim 15 wherein the post treatment formulation is formulated such that when exposed to the atmosphere or otherwise dried, the water in the post treatment formulation evaporates or is absorbed into the object.

20. The method of claim 15 wherein the post treatment formulation is formulated such that after application of the post treatment formulation, as the water leaves the system of the formulation in the porous material, the polymer molecules interact and polymerise.

23. The method of claim 15 wherein the post treatment formulation is formulated such that as the polymer particles fuse together, they form a stable film around the object.

24. The method of claim 15 wherein the post treatment emulsion is applied to the object or selected portions of the object after the object has been built.

25. The method of claim 15 wherein the post treatment formulation is applied by spray application or by immersing the object in the formulation.

26. A method of post treatment of a 3D printed object, the method including:
providing a 3D printed object, the 3D printed object comprising a plurality of media layers assembled together to form the object, wherein the media layers are of a porous material;
providing a post-treatment formulation;
applying a post-treatment emulsion to the object or portions of the object to wherein the post treatment formulation is configured as an infiltrant material;
wherein the porous material of the media layers is configured to act as a scaffold for the post treatment formulation;
the post treatment formulation comprising a colloidal suspension of an acrylic polymer in water; and
wherein the post treatment formulation is formulated such that after application of the post treatment formulation, as the water leaves the system of the formulation in the porous material, the polymer molecules interact and polymerise and form a stable film around the object.
